(19) United States
(12) Patent Application Publication
(10) Pub. No.: US 2025/0305481 A1
(43) Pub. Date: Oct. 2, 2025

(54) CONTROLLING A WIND TURBINE BASED ON WEAR TO WIND TURBINE ROTOR BLADE PITCH BEARINGS

(71) Applicant: VESTAS WIND SYSTEMS A/S, Aarhus N (DK)

(72) Inventors: Fabian SCHWACK, Aarhus C (DK); Lars Pallisgaard HANSEN, Hinnerup (DK); Frank Møller HANSEN, Arden (DK)

(21) Appl. No.: 18/862,933

(22) PCT Filed: Apr. 28, 2023
(86) PCT No.: PCT/DK2023/050101

§ 371 Date: Nov. 4, 2024

(30) Foreign Application Priority Data
May 2, 2022 (DK) PA202270231

(51) Int. Cl. F03D 7/02; F03D 1/06; F03D 17/00; F03D 80/70

(52) U.S. Cl. CPC F03D 7/0224; F03D 1/0667; F03D 17/012; F03D 80/701; F05B 2240/50; F05B 2260/79

(57) ABSTRACT

The invention provides for controlling a wind turbine comprising pitch-adjustable rotor blades. The invention involves determining, based on detected wind conditions, wind turbine control parameters for controlling the wind turbine in accordance with a defined wind turbine control strategy, where the control parameters include a reference pitch angle for the rotor blades. The invention involves obtaining bearing control parameters each indicative of a parameter for controlling pitch bearings of the wind turbine that is for adjusting pitch of the rotor blades. The invention involves determining whether a defined set of operational parameters of the wind turbine, including the bearing control parameters, in combination correspond to a combination of operational parameters defined to be indicative of a level of wear above a threshold wear level. The pitch bearings are then controlled based on the reference pitch angle and on the threshold determination.

### TECHNICAL FIELD

The invention relates to controlling a wind turbine and, in particular, to controlling pitch of one or more rotor blades of the wind turbine based on wear to the pitch bearings of the rotor blades.

### BACKGROUND

Wind turbines as known in the art include a wind turbine tower supporting a nacelle and a rotor with a number of—typically, three-pitch—adjustable rotor blades mounted thereto. Wind turbine controllers are used to adjust the pitch of the wind turbine rotor blades in accordance with defined wind turbine control strategies based on prevailing wind conditions, e.g. wind speed, in the vicinity of the wind turbine. Typically, such control strategies may be used to reduce or minimise loads experienced by one or more components a wind turbine, and/or increase or maximise output power generated by the wind turbine.

Each rotor blade of a wind turbine generally includes a pitch bearing (or rotor blade bearing) that connects a rotor hub of the wind turbine to the respective rotor blade, which allows for pitch angle adjustment of the rotor blade relative to the rotor hub, i.e. rotational movement of the blade about its own axis. The pitch bearings are typically of grease-lubricated, rolling element bearings to facilitate the required pivoting movement.

The pitch angle of the rotor blades may be adjusted as part of collective and/or individual pitch control routines of the wind turbine (pitch) controller(s). Blade pitch control involves repeated, frequent oscillating or reciprocating movements between the rolling elements and raceways/channels/grooves of the pitch bearings. Oscillatory motion of the pitch bearings can also result from vibrations of the wind turbine, e.g. during a wind gust, or from load variations. The oscillatory motion can lead to wear or damage of the pitch bearing, thereby reducing its service life. In particular, the oscillatory movement of the pitch bearing can cause lubricant between the component parts of the bearing—e.g. rolling elements and raceway-to be squeezed out of the bearing.

A wind turbine is generally subject to many different operating parameters or conditions. These can include wind conditions in the vicinity of the wind turbine, conditions specific to a location/site of the wind farm in which the wind turbine is located (e.g. terrain), and different operating modes of the wind turbine (e.g. rated mode, derated mode, standstill mode, etc.). Different turbines may also include different types of components (of different dimensions, for instance) and different materials, such as the type of grease used to lubricate the rotor blade pitch bearings.

Different combinations of operating conditions and parameters can cause different levels of wear to wind turbine pitch bearings. It is desirable to be able to operate wind turbines in a manner in which the lifespan of the rotor blade bearings is preserved, i.e. to reduce wear suffered by the pitch bearings.

It is against this background to which the present invention is set.

### SUMMARY OF THE INVENTION

According to an aspect of the invention there is provided a method for a wind turbine comprising a plurality of pitch-adjustable rotor blades. The method comprises receiving sensor data indicative of wind conditions in the vicinity of the wind turbine. The method comprises determining, based on the received sensor data, one or more wind turbine control parameters for controlling the wind turbine in accordance with a defined wind turbine control strategy. The one or more wind turbine control parameters includes a reference pitch angle for at least one of the rotor blades. The method includes obtaining at least one bearing control parameter each indicative of a parameter for controlling at least one pitch bearing of the wind turbine that is for adjusting pitch of the at least one rotor blade. The method includes determining whether a defined set of operational parameters of the wind turbine, including the at least one bearing control parameter, in combination correspond to a combination of operational parameters defined to be indicative of a level of wear above a threshold wear level. The method comprises determining a control signal for controlling the at least one pitch bearing to adjust pitch of the at least one rotor blade, the control signal being determined based on the reference pitch angle and on whether the defined set of operational parameters exceeds the threshold wear level. The method may comprise transmitting the control signal to at least one pitch actuator of the wind turbine to control the at least one pitch bearing.

Optionally, the at least one bearing control parameter is obtained based on the reference pitch angle.

Optionally, the at least one bearing control parameter includes one or more of: blade pitch oscillation angle a blade pitch oscillation frequency and a number of blade pitch oscillation cycles.

Determining whether the defined set of operational parameters indicate a level of wear above the threshold level may comprise: accessing a database comprising a plurality of combinations of operational parameters each indicative of a level of wear above or below the threshold wear level; identifying the stored combination of operational parameters corresponding to current values of the defined set of operational parameters; and, determining whether the level of wear is above the threshold wear level based on the identified combination.

The database may comprise a plurality of sets of predefined combinations of operational parameters. Each set may correspond to a respective further operational parameter that influences the level of wear suffered by the at least one pitch bearing. The method may comprise identifying a current value of the further operational parameter. The method may comprise retrieving a predefined combination of operational parameters from the set corresponding to the current value of the further operational parameter.

The further operational parameter may be a type of grease used to lubricate the at least one pitch bearing. The further operational parameter may be an operating mode of the wind turbine. The further operational parameter may be a dimension of one or more components of the wind turbine. Optionally, the component is the at least one pitch bearing or the rotor blades.

Determining whether the defined set of operational parameters indicate a level of wear above the threshold level may comprise determining a value of wear parameter indicative of the level of wear based on current values of the defined set of operational parameters, and determining whether the determined wear parameter value exceeds the threshold wear level. The wear parameter value may be determined using a defined equation or algorithm. Such an algorithm may be derived from available operational parameter and wear data, for instance using a machine learning technique.

The wear parameter may be friction torque of the at least one pitch bearing, optionally maximum friction torque, e.g. over a certain time period. The wear parameter may correspond directly to wear of the at least one pitch bearing. The wear parameter may be temperature of the at least one pitch bearing. The wear parameter may be vibration of the at least on pitch bearing. The wear parameter may be sound of the at least on pitch bearing. The wear parameter may be iron content in lubricant of the at least one pitch bearing. The wear parameter may be radial play in the at least one bearing.

If current values of the defined set of operational parameters indicates that the threshold wear level is exceeded, then the control signal may be determined to control the at least one pitch bearing to perform a predefined plurality of oscillation cycles to relubricate the at least one bearing. This predefined plurality of oscillation cycles may be referred to as a grease stroke.

If current values of the defined set of operational parameters indicates that the threshold wear level is exceeded, then the method may comprise determining whether to adjust control of the wind turbine to reduce the level of wear below the threshold wear level. If it is determined to not adjust control of the wind turbine then the control signal may be determined to control the at least one pitch bearing to adjust pitch of the at least one rotor blade in accordance with the reference pitch angle.

If it is determined to adjust control of the wind turbine then the method may comprise modifying one or more control parameters of the wind turbine, and controlling the wind turbine to operate in accordance with the one or more modified control parameters. Optionally, modifying the control parameters includes one or more of: modifying a pitch rate limit for adjusting pitch of the at least one rotor blade; modifying the determined reference pitch angle; and, controlling a lubrication system of the wind turbine to relubricate the at least one pitch bearing.

The determination whether to adjust control of the wind turbine may be based on a determined trade-off between a predicted loss of annual energy production (AEP) if control of the wind turbine is adjusted, and a predicted level of damage to the at least one pitch bearing if control of the wind turbine is not adjusted.

If it is determined to not adjust control of the wind turbine then the method may comprise outputting a warning signal indicating that the at least one pitch bearing is being controlled to operate in a critical region of operation. If it is determined to not adjust control of the wind turbine then the method may comprise determining a remaining lifetime of the at least one bearing as a result of operating the at least one pitch bearing in the critical region of operation.

The at least one bearing control parameter may include one or more of: blade pitch oscillation angle; blade pitch oscillation frequency; and, a number of blade pitch oscillation cycles.

The steps of the method may be repeated at each time step of a controller implementing the method. At least one bearing control parameter value may be obtained based on the output of the controller at each of a plurality of previous time steps, i.e. based on output data from (a defined plurality of) historical time steps.

According to another aspect of the present invention there is provided a controller for a wind turbine comprising a plurality of pitch-adjustable rotor blades. The controller is configured to receive sensor data indicative of wind conditions in the vicinity of the wind turbine. The controller is configured to determine, based on the received sensor data, one or more wind turbine control parameters for controlling the wind turbine in accordance with a defined wind turbine control strategy. The one or more wind turbine control parameters includes a reference pitch angle for at least one of the rotor blades. The controller is configured to obtain, based on the reference pitch angle, at least one bearing control parameter each indicative of a parameter for controlling at least one pitch bearing of the wind turbine that is for adjusting pitch of the at least one rotor blade. The controller is configured to determine whether a defined set of operational parameters of the wind 30 turbine, including the at least one bearing control parameter, in combination correspond to a combination of operational parameters defined to be indicative of a level of wear above a threshold wear level. The controller is configured to determine a control signal for controlling the at least one pitch bearing to adjust pitch of the at least one rotor blade, the control signal being determined based on the reference pitch angle and on whether the defined set of operational parameters exceeds the threshold wear level. The controller is configured to transmit the control signal to at least one pitch actuator of the wind turbine to control the at least one pitch bearing.

According to another aspect of the invention there is provided a wind turbine comprising a controller as defined above.

According to another aspect of the invention there is provided a non-transitory, computer-readable storage medium storing instructions thereon that when executed by one or more processors cause the one or more processors to execute the method defined above.

### BRIEF DESCRIPTION OF THE DRAWINGS

Examples of the invention will now be described with reference to the accompanying drawings, in which:

FIG. 1 schematically illustrates a wind turbine in accordance with an aspect of the invention;

FIG. 2 schematically illustrates a plot indicating a region of operational parameter space of the wind turbine of FIG. 1 that is estimated to result in a level of wear of at least one pitch bearing of the wind turbine above a defined threshold level;

FIG. 3 schematically illustrates a controller of the wind turbine of FIG. 1 in accordance with an aspect of the invention; and,

FIG. 4 shows the steps of a method performed by the controller of FIG. 3 in accordance with an aspect of the invention.

### DETAILED DESCRIPTION

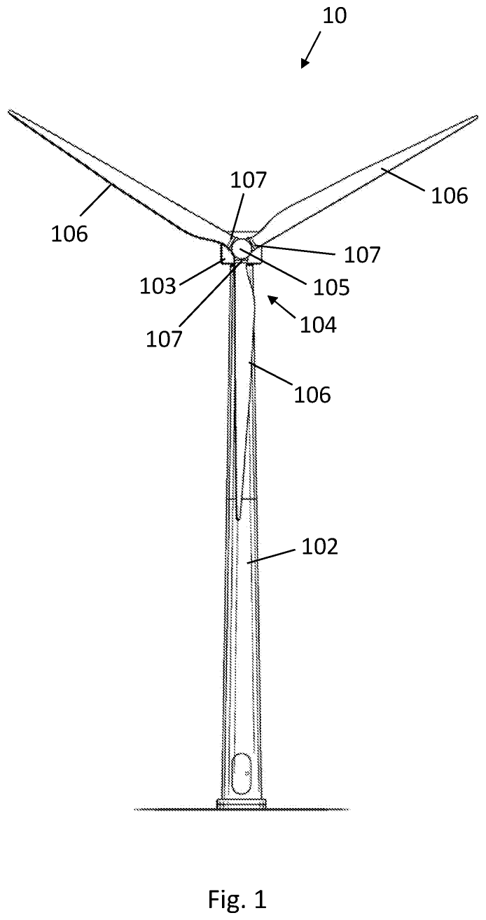

FIG. 1 shows a schematic illustration of an example of a wind turbine 10. The wind turbine 10 includes a tower 102, a nacelle 103 disposed at the apex of, or atop, the tower 102, and a rotor 104 operatively coupled to a generator (not shown) housed inside the nacelle 103. In addition to the generator, the nacelle 103 houses other components required for converting wind energy into electrical energy and various components needed to operate, control, and optimise the performance of the wind turbine 10. The rotor 104 of the wind turbine 10 includes a central hub 105 and three rotor blades 106 that project outwardly from the central hub 105. Moreover, the wind turbine 10 comprises a control system or controller (not shown in FIG. 1). The controller may be placed inside the nacelle 103, in the tower 102 or distributed at a number of locations inside (or externally to) the turbine 10 and communicatively connected to one another.

The rotor blades 106 are pitch-adjustable. The rotor blades 106 may be adjusted in accordance with a collective pitch setting, where each of the blades are set to the same pitch value. In addition, the rotor blades 106 may be adjustable in accordance with individual pitch settings, where each blade 106 may be provided with an individual pitch setpoint.

In order that the pitch of the rotor blades 106 may be adjusted, each rotor blade 106 is coupled to the rotor hub 105 via a respective pitch bearing (or rotor blade bearing) 107. Each pitch bearing 107 enables the respective rotor blade 106 to move, rotate, or pivot around its longitudinal axis relative to the rotor hub 105 (and other components of the wind turbine). This therefore allows an angle of attack of the respective rotor blade 106 to be adjusted relative to the prevailing wind direction in the vicinity of the wind turbine 10. In this way, the loading experienced by the wind turbine rotor blades 106, and other components of the wind turbine 10, can be minimised or reduced, and/or power output of the wind turbine 10 can be maximised or increased.

The pitch bearings 107 are typically rolling element bearings in which rolling elements roll in one or more raceways of the pitch bearing 107 to permit rotation of the blade 106 relative to the rotor hub 105. In order to prevent damage as a result of the rolling movement between the rolling elements and the contact surface of the raceways, the pitch bearings 107 are lubricated, typically with a grease lubricant.

Modern blade pitch control routines for wind turbines may mean that the rotor blade pitch is being adjusted frequently, for instance as part of collective and/or individual pitch control routines. Furthermore, pitch adjustments tend to involve relatively small, oscillatory motion, meaning that the rolling elements of the pitch bearings are controlled to roll back and forth in an oscillatory manner over a relatively small contact surface area of the raceways.

Wear can occur at the contact area between the pitch bearing elements if there is an insufficient amount of lubricant to maintain separation between the elements. In particular, the relatively small, frequent oscillatory movement between the rolling elements and raceways may contribute to insufficient lubricant film formation between the bearing elements.

Pitch bearings have an intended service life of typically several years, e.g. 20 years. Repeated or extended operation of the wind turbine in a manner in which there is unduly high levels of contact between the pitch bearing elements can contribute to wear of the elements such that the actual service life of the pitch bearing is lower than the intended time period.

There are a variety of different combinations of operating parameters and conditions of a wind turbine that can lead to operation to the pitch bearings that results in increased wear, e.g. where there is insufficient lubricant formation. These parameters can include the properties of the particular grease being used as the bearing lubricant, the operating mode in which the wind turbine is being operated, the wind conditions in which the wind turbine is operating, and control parameters indicative of how one or more of the wind turbine components are being controlled, for instance.

As well as the oscillations of the pitch bearing elements that result from how the rotor blade pitch is being controlled, other (unwanted) oscillations can result from vibrations of the wind turbine, which may be caused by wind gusts in the vicinity of the wind turbine, for instance. Such oscillations also cause lubricant to be squeezed out the pitch bearing, leading to increased risk of wear or damage.

The present invention is advantageous in that it identifies when a wind turbine is operating in a manner that may cause an undue amount of wear or damage to the pitch bearing of the wind turbine rotor blades. The invention advantageously provides for controlling a wind turbine such that operation in such a manner may be prevented or mitigated against, or its benefits or drawbacks may be balanced against other factors that influence wind turbine control, such as a level of power output of the wind turbine, e.g. annual energy production (AEP). In this way, the lifetime of the wind turbine pitch bearings—or one or more components thereof—may be preserved, or not unduly reduced. As described in greater detail below, the invention achieves these advantages by taking into account a degree of wear associated with operation of a wind turbine under a given set of operational parameters when controlling operation of the wind turbine.

It may be ascertained a priori certain combinations of wind turbine operating/operational parameters and conditions that result in increased risk of wear of the pitch bearing components. The different operational parameter combinations may be tested experimentally, and a (wear) parameter indicative of the level of wear associated with operation under such operational parameter combinations may be measured or otherwise obtained.

Herein, the term ‘wind turbine operational parameter’ (or, simply, ‘operational parameter’) may be used to refer to any parameter or condition that influences, or is indicative of, operation of the wind turbine. This can include a mode of operation in which the wind turbine is being operated, such as a rated mode of operation, a derated mode of operation, a standstill or shut down mode, etc.

The operational parameters can include parameters relating to a wind farm in which the wind turbine 10 is located, such as terrain in the vicinity of the wind turbine 10, the positioning of other wind turbines of the wind farm relative to the wind turbine 10, etc. The operational parameters can include parameters relating to the specific dimensions and/or materials of the wind turbine 10, such as the type of grease used to lubricate the pitch bearings 107, the dimensions of the rotor blades 106 and/or pitch bearings 107, etc. The operational parameters can include parameters relating to the prevailing wind conditions in the vicinity of the wind turbine 10, such as wind speed and/or direction, a detected level of wind turbulence and/or wind shear, etc.

The operational parameters include one or more parameters relating to control of the pitch bearing(s) 107 to cause pitch adjustment of the rotor blades 106. These parameters may be referred to as ‘bearing control parameters’. The bearing control parameters can include oscillation amplitude/angle, oscillation frequency and number of oscillation cycles of the pitch bearing, specifically the rolling elements in the raceway(s).

As mentioned above, certain combinations of a defined set of wind turbine operational parameters may be associated with a certain level of wear to one or more parts of the pitch bearing(s) 107. In some examples, a ‘wear parameter’ (or ‘tribological parameter’) is used as an indication of the level of wear to the pitch bearing 107 associated with a certain set of operational parameters. In particular, the term ‘wear parameter’ is used herein to refer to a quantity associated with a wind turbine pitch bearing 107, and which is indicative of predicted, estimated or observed damage or wear to one or more parts of the pitch bearing 107 when operating under a certain set of operational parameters or conditions. The wear parameter may be a parameter that can be measured when the wind turbine 10 is operating, or may be a parameter than can be estimated based on a given set of one or more wind turbine operating conditions.

In one example, the wear parameter may be frictional torque of the pitch bearing 107, e.g. between the rolling element and the raceway at a point of contact during operation. For instance, in experimentation the frictional torque may be measured during operation under certain conditions and may be compared with a resulting amount of wear of the components during such operation. The particular wear parameter of interest may be the maximum frictional torque over a certain period of operation with certain operating conditions, which in turn is then associated with a certain level of pitch bearing wear.

In other examples, the wear parameter may be a different parameter, such as a temperature, a sound/noise level, or a level of vibration of the one or more pitch bearings 107. The wear parameter could also be an amount of iron content in the lubricant in the one or more pitch bearings 107, as this can be indicative of the degree to which there has been contact and scraping between rolling elements and raceways. The wear parameter may also be an amount of radial play/movement of the pitch bearing 107, as this can be indicative of bearing surfaces being worn away such that greater movement between components in a radial direction becomes possible.

In further other examples, the wear parameter may be a measure of an amount of wear or damage itself to one or more parts of the pitch bearing 107.

The wear parameter may be a combination of quantities, such as a combination of two or more of the quantities mentioned above, in order to provide the required indication of wear. As such, in some examples the wear parameter may not correspond directly to a physical quantity.

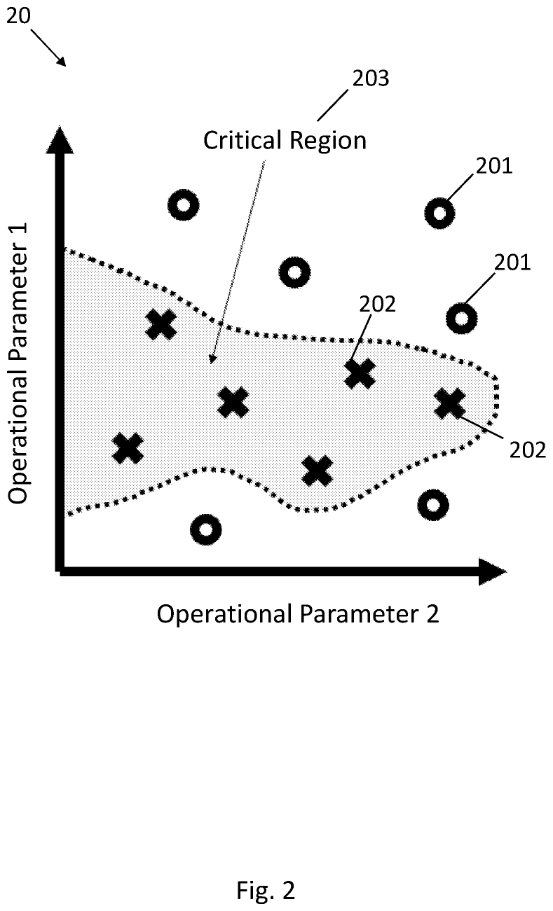

FIG. 2 illustrates a schematic plot or matrix 20 of how certain combinations of wind turbine operational parameters are associated with different levels of wear of the wind turbine pitch bearing. The data points indicated in FIG. 2 may for instance be obtained via testing, experimentation and/or literature references. In the illustrative example of FIG. 2, values of a first operational parameter-Operational Parameter 1—are plotted against values of a second operational parameter-Operational Parameter 2—for several different combinations of the operational parameters. The first and second operational parameters may be any suitable operational parameters, such as from the examples of operational parameters outlined above.

Each data point—i.e. each combination of the first and second operational parameters—is associated with a certain level of wear that operation of the wind turbine 10 under such operating conditions will cause. As outlined above, any suitable wear parameter may be used to determine the level of wear for a given combination of operating conditions.

Based on the level of wear associated with each of the obtained data points, one or more regions of operational space may be defined in which a level of wear of the pitch bearing 107 is above a certain threshold, e.g. indicative of a level of wear that is unduly high. In particular, data points 201 that are outside of such an operating region may indicate that operation of the wind turbine 10 under such operating conditions does not cause an unduly or unacceptably high level of pitch bearing wear such that operation of the wind turbine 10 in this operating region may be permitted to continue without modification for reasons of wear.

On the other hand, data points 202 that are inside such an operating region-which may be referred to as a critical region 203—may indicate that operation of the wind turbine 10 under such operating conditions result in an unduly high level of wear to the pitch bearing 107, e.g. above a defined threshold wear level. The critical region 203 may be extrapolated from the available data points 201, 202 in any suitable manner, e.g. by inspection or by a regression method.

In the schematic example of FIG. 2, it is seen that for sufficiently low, or sufficiently high, values of Operational Parameter 1, the level of wear experienced by the pitch bearing 107 is below the threshold level irrespective of the value of Operational Parameter 2. For other values of Operational Parameter 1, the level of wear is above or below the threshold value (i.e. inside or outside of the critical region 203) depending on the value of Operational Parameter 2.

In one example, one or both of the first and second operational parameters in FIG. 2 may be bearing control parameters as defined above. For instance, Operational Parameter 1 may be oscillation angle of the pitch bearing(s) 107 and Operational Parameter 2 may be oscillation frequency of the pitch bearing(s) 107. The level of bearing wear associated with each combination of oscillation angle and frequency values—i.e. each data point—may be quantified or indicated by a wear parameter in the form of maximum frictional torque of the pitch bearing 107. In this example, each of the data points 201 has a measured maximum frictional torque that is below a defined threshold maximum frictional torque that indicates a maximum frictional torque level above which pitch bearing wear is unduly high. On the other hand, each of the data points 202 has an associated maximum frictional torque that exceeds the defined threshold value. The critical region 203 may then be extrapolated based on the available data points 201, 202 and their associated maximum frictional torque values.

In the example illustrated in FIG. 2, it is determined whether the level of wear of the pitch bearing 107 is predicted or estimated to be above a certain threshold based on a combination of two operational parameters. It will be understood, however, that the number of operational parameters on which determination is made may be greater or less than this. In particular, a set of one or more wind turbine operational parameters may be defined, and it is then determined whether the combination of (current values of) operational parameters in the defined set will result in a level of pitch bearing wear that is above a threshold level.

In one example, a combination of three operational parameters may be evaluated to determine whether the level of wear is unduly high. In such an example, a three-dimensional plot or matrix (rather than a two-dimensional plot as in FIG. 2) of three-dimensional data points may be constructed. For instance, the three operational parameters could be three bearing control parameters, e.g. oscillation angle, oscillation frequency, and number of oscillation cycles. A specific example in which a combination of oscillation angle, frequency and number of oscillation cycles is considered is in the case of so-called ‘false brinelling’, in which case wear or damage is caused as a result of insufficient lubrication at part of the pitch bearing 107. More generally, an n-dimensional plot/matrix may be constructed, where n is the number of operational parameters.

In the above examples, the operational parameters being considered are parameters that may be plotted along a numerical axis, i.e. parameters that may be regarded as having a certain value, such as oscillation angle, oscillation frequency, and number of oscillation cycles, but optionally also parameters such as wind speed/direction, rotor blade loading measurements, etc. However, as outlined above, different types of operational parameters—that may be less readily represented along a numerical axis—may also be included in the defined set of operational parameters used to determine whether the level of bearing wear is within preferred limits. One such (further) operational parameter may be the particular type of grease used in the pitch bearings 107 of the wind turbine 10. For instance, a plot or matrix such as that illustrated in FIG. 2 may be relevant for a particular type of grease (having certain properties, such as a specific viscosity value), whereas a different plot/matrix of Operational Parameters 1 and 2 (e.g. oscillation angle and oscillation frequency) with a different critical region may be relevant for a different type of grease. Similarly, different plots/matrices—with different critical regions/spaces—may be defined for different operating modes of the wind turbine 10, or any other suitable operating parameters (that do not define an axis of the plot).

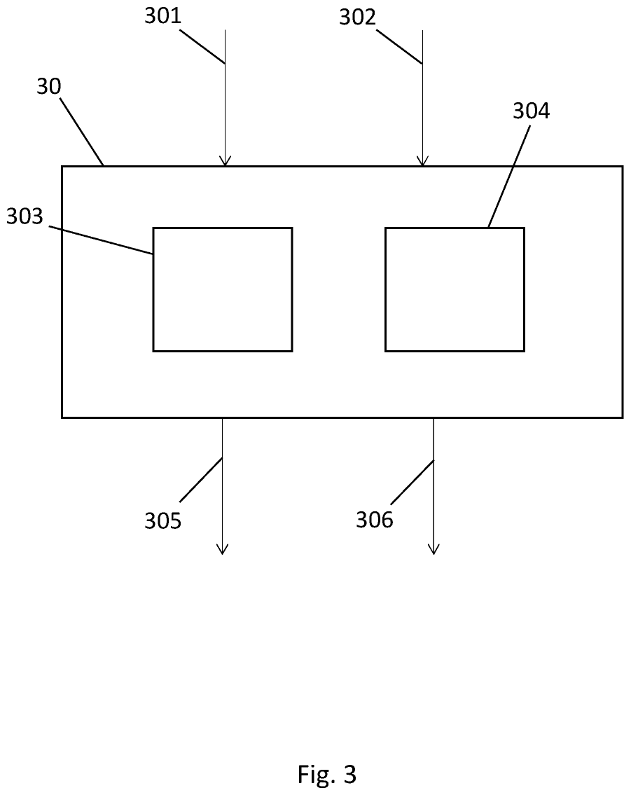

FIG. 3 schematically illustrates a controller 30 of the wind turbine 10 in accordance with an example of the invention. The controller 30 controls operation of the wind turbine 10 in a manner that takes into account the predicted level of wear of the pitch bearings 107 under certain operational parameters.

The controller 30 is configured to receive as an input various sensor data/signals to be used to determine how to control operation of the wind turbine 10. In particular, the controller 30 is configured to receive sensor data indicative of the wind conditions in the vicinity of the wind turbine 10. Specifically, the controller 30 receives a signal 301 indicative of wind speed, and optionally other wind/environmental conditions such as wind direction. The wind speed signal 301 is received from one or more suitable sensors for measuring wind speed. For instance, one or more accelerometers may be used, such as an accelerometer positioned on the wind turbine 10 (e.g. atop the nacelle 103) or elsewhere in a wind farm in which the wind turbine 10 is located. The controller 30 may also be configured to receive a signal 302 indicative of the rotation speed of the rotor 105, which may be received from a suitable sensor located on or near to the rotor 105 or a rotor shaft of the wind turbine 10.

The controller 30 may include a control reference module 303 that uses the received wind speed signal 301 and rotor speed signal 302 to determine one or more control parameters for controlling operation of the wind turbine 10. In particular, the control parameters can include a reference pitch angle for one or more of the rotor blades 106, and/or a speed reference for a generator of the wind turbine 10. The control parameters are determined in accordance with a defined wind turbine control strategy, e.g. based on minimising component loading and/or maximising power output. In this way, the control reference module 303 may be regarded as corresponding to a conventional/standard wind turbine controller. Typically, such a standard controller would then generate a control signal to control the relevant components of a wind turbine in accordance with the determined control parameters, e.g. transmit a control signal to a pitch actuator of the wind turbine 10 to control a pitch bearing 107 to adjust blade pitch of the respective rotor blade 106 in accordance with the determined reference pitch angle.

Unlike in a conventional arrangement, however, in examples of the present invention there is an additional consideration as to the level of wear that is estimated or predicted to occur as a result of the wind turbine 10 operating in accordance with the control parameters determined by the control reference module 303, i.e. if the wind turbine 10 was operated based on control signals from a conventional wind turbine controller.

The additional functionality may be provided in a further module, referred to as a wear control module 304, of the controller 30. In particular, the wear control module 304 uses the control parameters determined by the control reference module 303 to estimate a level of pitch bearing wear associated with wind turbine operation in accordance with the determined control parameters, and whether adjustment of the determined control parameters is appropriate.

As described above with reference to FIG. 2, a defined set of operational parameters is used to predict or estimate a level of pitch bearing wear that will occur, and the estimated level of wear is compared against a defined threshold wear level to determine whether mitigating control action may be desirable.

The defined set of operational parameters includes at least one bearing control parameter (defined above). As mentioned, such bearing control parameters include oscillation angle, oscillation frequency, and number of oscillation cycles. These parameters may be obtained from the reference pitch angle output by the control reference module 303. For instance, controlling one of the rotor blades 106 based on, or in accordance with, a particular reference pitch angle may correspond to rolling the respective pitch bearing 107 around a particular angle, i.e. performing oscillations having a particular amplitude.

The frequency with which the oscillations are performed may be dependent on the reference pitch angle and/or other control parameters determined by the control reference module 303, or the frequency may be predetermined or pre-set in the controller 30. If the frequency is to be determined, then this may be determined based on a certain number of processor time steps of the controller 30.

The number of oscillation cycles performed by the pitch bearings 107 may be determined using a counter, for instance. The number of oscillation cycles may be tracked across time steps of the controller 30, for instance a defined number of time steps or a defined time period. The reference pitch angle at some or each time step may be used in the determination.

The defined set of operational parameters may further include operational parameters other than bearing control parameters, such as those outlined above. The particular operational parameters that are included in the set for predicting pitch bearing wear are defined a priori.

Some operational parameters that may be included in the defined set may have values that vary during operation of the wind turbine 10. The values of such operational parameters therefore need to be calculated, measured, or otherwise obtained, during wind turbine operation, for instance in real time. This would be the case for operational parameters such as the bearing control parameters, environmental parameters (such as wind speed, ambient temperature, etc.), a current operating mode of the wind turbine, etc.

Some other operational parameters that may be included in the defined set may be pre-set in the sense that they do not vary during operation of the wind turbine 10. Such operational parameters can be pre-set. This would be the case for operational parameters such as the type of grease used in the pitch bearings 107, various dimensions of the rotor blades 106 and/or pitch bearings 107, etc.

The wear control module 304 considers whether operating the wind turbine 10 with the particular combination of determined or pre-set values of the operational parameters in the defined set is associated with a level of wear of the pitch bearings 107 above or below a defined threshold wear level. The threshold wear level may be a level above which the wear occurring at the pitch bearing is regarded as being unduly high.

This determination may be made in a number of different ways. In some examples, the controller 30 may include, or be communicatively connected to, a memory that includes a database of various combinations of values (or ranges of values) of the operational parameters in the defined set. Each stored combination may be associated in the database with a defined level of wear, from which it can be determined whether the respective combination is above or below the defined threshold wear level. Alternatively, each stored combination may simply be associated in the database with an indication as to whether the respective combination of operational parameters is associated with a level of wear above or below the threshold level.

The different combinations of operational parameter values and the respective associated levels of wear (or indication of wear relative to the threshold) are determined a priori, e.g. via experimentation, testing or literature. In one example, the database may store this predetermined information in the form of a plot or matrix, e.g. as in the example illustrated in FIG. 2. In this way, the stored data (e.g. in the matrices) is static throughout operation of the wind turbine 10. The database may store a plurality of plots/matrices. For instance, different matrices may be provided for different types of grease, different types of wind turbine operating mode, etc. Within each matrix, a region/space may be defined as a critical region (in which wear is above the threshold) for different values of one or more operational parameters such as bearing control parameters. Different matrices may also be provided based on a current level of wear/damage of the pitch bearings, which may take into account how long the pitch bearing has been in service. For instance, a pitch bearing that has already suffered a certain amount of damage may be more susceptible to further damage. The matrix for a damaged bearing may have a larger critical region than for an undamaged matrix, for instance.

The wear control module 304 may then identify the relevant matrix in the database based on the relevant operational parameter values and determine whether the current set of operational parameter values is within the critical region, i.e. whether the wear level is above the threshold. Note that determining whether the particular combination of current operational parameter values exceeds the threshold wear level may or may not involve determining a wear parameter as described above, e.g. maximum frictional torque, and determining whether the (current) wear parameter exceeds a threshold.

The determination as to whether the current combination of parameter values may alternatively be determined using a defined algorithm or equation. For instance, a relationship, e.g. a mathematical relationship, may be defined that maps values of the respective operational parameter values to a wear parameter, e.g. maximum frictional torque, which may then be compared against the defined threshold value.

The controller 30 is configured to output a pitch angle control signal 305 to one or more pitch actuators of the wind turbine 10 for actuating the pitch bearing(s) 107 to adjust the pitch angle of the rotor blade(s) 106. The controller 30 may also be configured to output a generator speed control signal 306 to control the rotation speed of the wind turbine generator.

The controller 30—in particular, the wear control module 304—determines whether control action or adjustment is needed based on whether the determined wear level exceeds the defined threshold, and may then determine a control signal as appropriate. If the determined level of wear does not exceed the threshold level, e.g. is not in the critical region, then the controller 30 may determine that no adjustment of wind turbine operation to account for possible pitch bearing wear is needed. In such a case, the wind turbine 10 may be controlled in accordance with the reference control parameters determined by the reference control module 303. In particular, in this case the pitch angle control signal 305 may be to control the rotor blade pitch in accordance with the reference pitch angle determined by the reference control module 303 (in a conventional manner). In a similar manner, the generator speed control signal 306 may be to control the generator in accordance with the reference generator speed determined by the reference control module 303 (again in a conventional manner).

If the determined level of wear does exceed the threshold level, e.g. is in the critical region, then the controller 30 may determine whether adjustment of wind turbine operation to account for, or mitigate, possible pitch bearing wear is possible and/or appropriate. In particular, in the described example the controller 30 determines whether to adjust or modify the pitch angle control signal 305 (relative to a case in which wear is below the threshold) in order to achieve this. However, it will be appreciated that in different examples the generator speed control signal 306 may be adjusted or modified—either in addition to, or alternatively from, the pitch angle control signal 305—in order to mitigate against unduly high wear levels. It will also be appreciated that further different aspects of wind turbine operation may be modified in further different examples in order to guard against pitch bearing wear.

In one example, if the pitch bearing wear is determined to be above the threshold level then the controller 30 may be configured to output a pitch angle control signal 305 aimed at relubricating the pitch bearing(s) 107. This may be in the form of a predefined blade pitch angle control routine, and may be referred to as a ‘grease stroke’. A grease stroke may be regarded as controlling a pitch bearing 107 to perform a predefined plurality of oscillation cycles, e.g. of predefined (relatively large) amplitude, to allow relubrication of the at least one bearing 107, so as to guard against wear and high torque values. The amplitude of a grease stroke may be 3 to 5 degrees, for instance; however, it will be understood that this can be greater or less as needed. The particular nature of the grease stroke may also be determined based on the oscillation frequency of the pitch bearing(s). A grease stroke may additionally be performed if a pitch bearing has performed a certain number of relatively small amplitude oscillation cycles, e.g. if a certain pitch limit has been imposed for a relatively large time period: in particular, one or more relatively large pitch cycles may then be performed to allow relubrication of the pitch bearing, e.g. at a point of repeated contact during the small oscillation cycles. A grease stroke may be performed collectively, to each of the rotor blades 106, or individually, to a particular one of the rotor blades 106, as needed.

If the pitch bearing wear is determined to be above the threshold level then the controller 30, e.g. the wear control module 304, may be configured to determine whether it is necessary or desirable to operate the wind turbine 10 in accordance with the reference control parameters determined by the reference control module 303, and/or under the current values of the set of operational parameters, despite the damage that may be caused to the pitch bearing(s) 107. For instance, this determination may involve a consideration of the loss of power output, e.g. loss of annual energy production (AEP), that may result from modifying wind turbine operation away from the determined reference (optimal) points versus the level of damage or wear that may result from operating the wind turbine 10 in the critical wear region, e.g. estimating a reduction in component lifetime resulting from operation in the critical region, optionally based on design failure mode and effect (DFMEA) analysis. AEP and/or DFMEA data may be determined a priori and retrievable from the memory accessible by the controller 30, as required, or alternatively these may be determined in real time based on current operating conditions.

If it is determined that it is necessary or desirable to maintain current control/operating parameters irrespective of the potential resulting wear, then the controller 30 may be configured to output the pitch angle control signal 305 to control the pitch actuator(s) in accordance with the determined reference pitch angle. In such a case, the controller 30 may be configured to generate a warning signal, e.g. an audio and/or visual alarm output to an operator of the wind turbine, that the pitch bearing 107 is being controlled to operate in a critical region of operation. Alternatively, or in addition, the estimated or predicted level of wear associated with continued operation in a critical region may be used to determine a remaining lifetime, e.g. in months or years, of the pitch bearings 107 or associated components, or to what extent the lifetime will be reduced as a result of operation in the critical region.

If, however, it is determined that control of the wind turbine 10 is to be adjusted to guard against wear, then the controller 30 may determine one or more control signals for controlling the wind turbine 10 in a manner that results in the wind turbine 10 moving out of the critical region of operation, i.e. below the threshold level of wear. For instance, the controller 30 may be configured to adjust a pitch rate limit—i.e. a limit on the rate at which pitch angle may be adjusted—in order to move operation of the wind turbine 10 out of the critical region. The controller 30 may alternatively or additionally modify the reference pitch angle determined by the reference control module 303 and/or the oscillation frequency. Further alternatively, if the wind turbine 10 has a lubrication system/mechanism, then the controller 30 may control the lubrication system to provide lubrication to the pitch bearing(s) 107 in order to guard against wear in the critical region.

Adjustment of control of operation of the wind turbine 10 to reduce predicted wear to below the threshold level may be performed on an iterative basis. For instance, pitch rate limit may be modified, and then a further determination of whether the current values of the defined set of operational parameters are still associated with a level of wear above the threshold level may be made. The pitch rate limit may then be further modified as needed/appropriate.

The described controller 30 may be in the form of any suitable computing device, for instance one or more functional units or modules implemented on one or more computer processors. Such functional units may be provided by suitable software running on any suitable computing substrate using conventional or customer processors and memory. The one or more functional units may use a common computing substrate (for example, they may run on the same server) or separate substrates, or one or both may themselves be distributed between multiple computing devices. A computer memory may store instructions for performing the methods performed by the controller, and the processor(s) may execute the stored instructions to perform the method.

Although the controller 30 has been described as being implemented with the processing modules 303, 304, it will be understood that the controller may include any suitable number of modules or sub-modules to implement the described functionality. Furthermore, the described controller may be separate controllers: for instance, a controller may be provided to perform the determination steps relating to assessment of pitch bearing wear that is separate from a (conventional) controller for determining wind turbine control parameters such as pitch angle reference and generator speed reference.

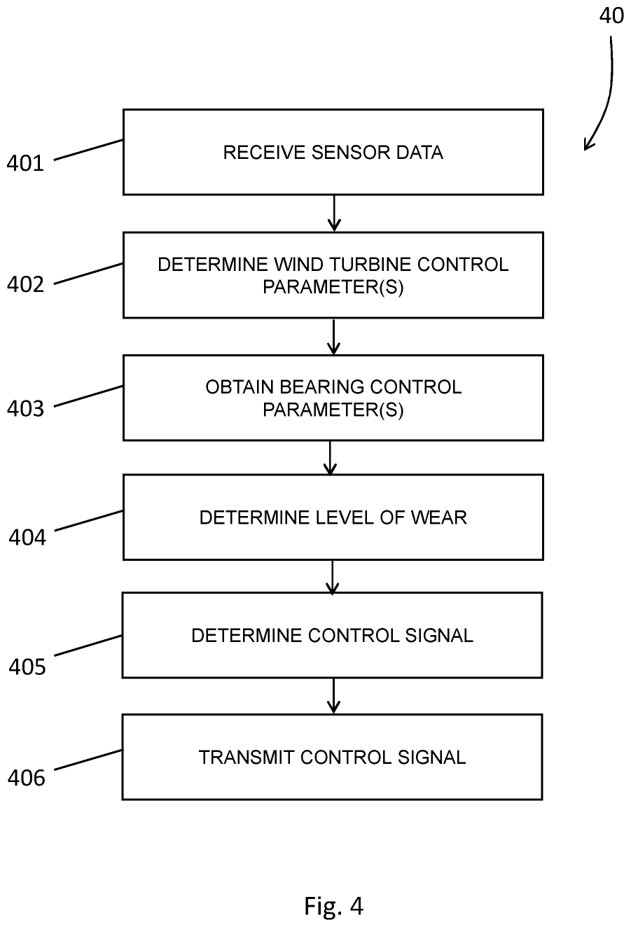

FIG. 4 summarises the steps of a method 40 performed by the wind turbine controller 30. At step 401, the controller 30 is configured to receive sensor data indicative of wind conditions in the vicinity of the wind turbine 10. This data signal 301 may be received from one or more wind measurement sensors of the wind turbine 10, for instance in a conventional manner. The controller 30 may also receive a rotor speed signal 302 indicative of rotational speed of the rotor 105. The controller 30 may receive further signals indicative of wind turbine operation, e.g. load signals from one or more wind turbine load sensors indicative of loading experienced by certain turbine components, e.g. blade flap loading.

At step 402 of the method 40, the controller 30 uses the received signals 301, 302 to determine control parameters for controlling the wind turbine 10 in accordance with a defined wind turbine control strategy. The control strategy may for instance be defined to achieve a desired balance between maximising power generation while maintaining the loading of one or more wind turbine components within acceptable levels. The control parameters include a reference pitch angle for one or more of the rotor blades 106, e.g. a collective and/or individual blade pitch reference.

At step 403 of the method 40, the controller 30 obtains at least one bearing control parameter, e.g. bearing oscillation angle/amplitude. This may be pre-set and available directly to the controller 30. Alternatively, the bearing control parameter(s) may be obtained from, or determined based on, the control parameters, e.g. the reference pitch angle. Each bearing control parameter is indicative of a parameter for controlling at least one pitch bearing of the wind turbine that is for adjusting pitch of the rotor blades 106.

At step 404 of the method 40, the controller 30 determines whether a defined set of operational parameters of the wind turbine 10 in combination correspond to a combination of operational parameters defined to be indicative of a level of wear above a threshold wear level. The operational parameter set includes at least one bearing control parameter. The determination may be made with reference to stored data associating operational parameter data/conditions with resulting levels of wear to the pitch bearings 107, or at least the resulting level of wear relative to a defined threshold level indicative of a critical level of wear or damage. The stored data may be in the form of plots or matrices defining critical regions of operation, optionally with different plots or matrices for certain different operational parameter values/types.

At step 405 of the method 40, the controller 30 determines a control signal 305 for controlling the pitch bearing(s) 107 to adjust pitch of the respective rotor blade 106. The control signal is determined based on the reference pitch angle and on whether the defined set of operational parameters exceeds the threshold wear level. If the threshold wear level is exceeded then one or more control actions may be implemented. For instance, a grease stroke operation may be implemented to relubricate the pitch bearings 107. Alternatively, or additionally, the pitch rate limit implemented by the controller 30 to control pitch angle in accordance with the determined reference may be adjusted to allow for greater recovery of grease into areas/regions of the bearing at which grease has been squeezed out during operation.

At step 406 of the method 40, the controller 30 transmits the control signal 305 to a pitch actuator(s) of the wind turbine 10 to control the pitch bearing(s) 107. The controller 30 may also transmit a control signal 306 to control generator speed of the wind turbine 10 in accordance with a determined reference value.

Many modifications may be made to the examples described herein without departing from the scope of the appended claims.

1. A method for a wind turbine comprising a plurality of pitch-adjustable rotor blades, the method comprising:
receiving sensor data indicative of wind conditions in the vicinity of the wind turbine;
determining, based on the received sensor data, one or more wind turbine control parameters for controlling the wind turbine in accordance with a defined wind turbine control strategy, the one or more wind turbine control parameters including a reference pitch angle for at least one of the rotor blades;
obtaining at least one bearing control parameter each indicative of a parameter for controlling at least one pitch bearing of the wind turbine that is for adjusting pitch of the at least one rotor blade, wherein the at least one bearing control parameter includes one or more of: blade pitch oscillation angle; blade pitch oscillation frequency; and, a number of blade pitch oscillation cycles;
determining whether a defined set of operational parameters of the wind turbine, including the at least one bearing control parameter, in combination correspond to a combination of operational parameters defined to be indicative of a level of wear above a threshold wear level;
determining a control signal for controlling the at least one pitch bearing to adjust pitch of the at least one rotor blade, the control signal being determined based on the reference pitch angle and on whether the defined set of operational parameters exceeds the threshold wear level; and,
transmitting the control signal to at least one pitch actuator of the wind turbine to control the at least one pitch bearing.

2. The method according to claim 1, wherein determining whether the defined set of operational parameters indicate a level of wear above the threshold level comprises:
accessing a database comprising a plurality of combinations of operational parameters each indicative of a level of wear above or below the threshold wear level;
identifying the stored combination of operational parameters corresponding to current values of the defined set of operational parameters; and,
determining whether the level of wear is above the threshold wear level based on the identified combination.

3. The method according to claim 2, wherein the database comprises a plurality of sets of predefined combinations of operational parameters, each set corresponding to a respective further operational parameter that influences the level of wear suffered by the at least one pitch bearing, the method comprising:
identifying a current value of the further operational parameter; and,
retrieving a predefined combination of operational parameters from the set corresponding to the current value of the further operational parameter.

4. The method according to claim 3, wherein the further operational parameter is one of:
a type of grease used to lubricate the at least one pitch bearing;
an operating mode of the wind turbine; and,
a dimension of one or more components of the wind turbine, optionally wherein the component is the at least one pitch bearing or the rotor blades.

5. The method according to claim 1, wherein determining whether the defined set of operational parameters indicate a level of wear above the threshold level comprises determining, using a defined equation or algorithm, a value of wear parameter indicative of the level of wear based on current values of the defined set of operational parameters, and determining whether the determined wear parameter value exceeds the threshold wear level.

6. The method according to claim 1, wherein the wear parameter is one of:
friction torque of the at least one pitch bearing;
wear of the at least one pitch bearing;
temperature of the at least one pitch bearing;
vibration of the at least on pitch bearing;
sound of the at least on pitch bearing;
iron content in lubricant of the at least one pitch bearing; and,
radial play in the at least one bearing.

7. The method according to claim 1, wherein if current values of the defined set of operational parameters indicates that the threshold wear level is exceeded, then the control signal is determined to control the at least one pitch bearing to perform a predefined plurality of oscillation cycles to relubricate the at least one bearing.

8. The method according to claim 1, wherein if current values of the defined set of operational parameters indicates that the threshold wear level is exceeded, then the method comprises determining whether to adjust control of the wind turbine to reduce the level of wear below the threshold wear level, wherein if it is determined to not adjust control of the wind turbine then the control signal is determined to control the at least one pitch bearing to adjust pitch of the at least one rotor blade in accordance with the reference pitch angle.

9. The method according to claim 8, wherein if it is determined to adjust control of the wind turbine then the method comprises modifying one or more control parameters of the wind turbine, and controlling the wind turbine to operate in accordance with the one or more modified control parameters; optionally wherein modifying the control parameters includes one or more of: modifying a pitch rate limit for adjusting pitch of the at least one rotor blade; modifying the determined reference pitch angle; and, controlling a lubrication system of the wind turbine to relubricate the at least one pitch bearing.

10. The method according to claim 8, wherein the determination whether to adjust control of the wind turbine is based on a determined trade-off between a predicted loss of annual energy production (AEP) if control of the wind turbine is adjusted, and a predicted level of damage to the at least one pitch bearing if control of the wind turbine is not adjusted.

11. The method according to claim 8, wherein if it is determined to not adjust control of the wind turbine then the method comprises at least one of:
outputting a warning signal indicating that the at least one pitch bearing is being controlled to operate in a critical region of operation; and,
determining a remaining lifetime of the at least one bearing as a result of operating the at least one pitch bearing in the critical region of operation.

12. (canceled)

13. The method according to claim 1, wherein the steps of the method are repeated at each time step of a controller implementing the method, and wherein at least one bearing control parameter value is obtained based on the output of the controller at each of a plurality of previous time steps.

14. A controller for a wind turbine comprising a plurality of pitch-adjustable rotor blades, the controller being configured to perform an operation, comprising:
receiving sensor data indicative of wind conditions in the vicinity of the wind turbine;
determining, based on the received sensor data, one or more wind turbine control parameters for controlling the wind turbine in accordance with a defined wind turbine control strategy, the one or more wind turbine control parameters including a reference pitch angle for at least one of the rotor blades;
obtaining at least one bearing control parameter each indicative of a parameter for controlling at least one pitch bearing of the wind turbine that is for adjusting pitch of the at least one rotor blade, wherein the at least one bearing control parameter includes one or more of: blade pitch oscillation angle; blade pitch oscillation frequency; and, a number of blade pitch oscillation cycles;
determining whether a defined set of operational parameters of the wind turbine, including the at least one bearing control parameter, in combination correspond to a combination of operational parameters defined to be indicative of a level of wear above a threshold wear level;
determining a control signal for controlling the at least one pitch bearing to adjust pitch of the at least one rotor blade, the control signal being determined based on the reference pitch angle and on whether the defined set of operational parameters exceeds the threshold wear level; and,
transmitting the control signal to at least one pitch actuator of the wind turbine to control the at least one pitch bearing.

15. (canceled)

16. The controller according to claim 14, wherein determining whether the defined set of operational parameters indicate a level of wear above the threshold level comprises:
accessing a database comprising a plurality of combinations of operational parameters each indicative of a level of wear above or below the threshold wear level;
identifying the stored combination of operational parameters corresponding to current values of the defined set of operational parameters; and,
determining whether the level of wear is above the threshold wear level based on the identified combination.

17. The controller according to claim 16, wherein the database comprises a plurality of sets of predefined combinations of operational parameters, each set corresponding to a respective further operational parameter that influences the level of wear suffered by the at least one pitch bearing, the method comprising:
identifying a current value of the further operational parameter; and,
retrieving a predefined combination of operational parameters from the set corresponding to the current value of the further operational parameter.

18. The controller according to claim 17, wherein the further operational parameter is one of:
a type of grease used to lubricate the at least one pitch bearing;
an operating mode of the wind turbine; and,
a dimension of one or more components of the wind turbine, optionally wherein the component is the at least one pitch bearing or the rotor blades.

19. A wind turbine, comprising:
a tower;
a nacelle disposed on the tower;
a rotor extending from the nacelle and having a plurality of of pitch-adjustable rotor blades disposed on a distal end thereof; and
a controller being configured to:
receive sensor data indicative of wind conditions in the vicinity of the wind turbine;
determine, based on the received sensor data, one or more wind turbine control parameters for controlling the wind turbine in accordance with a defined wind turbine control strategy, the one or more wind turbine control parameters including a reference pitch angle for at least one of the rotor blades;
obtain at least one bearing control parameter each indicative of a parameter for controlling at least one pitch bearing of the wind turbine that is for adjusting pitch of the at least one rotor blade;
determine whether a defined set of operational parameters of the wind turbine, including the at least one bearing control parameter, in combination correspond to a combination of operational parameters defined to be indicative of a level of wear above a threshold wear level;
determine a control signal for controlling the at least one pitch bearing to adjust pitch of the at least one rotor blade, the control signal being determined based on the reference pitch angle and on whether the defined set of operational parameters exceeds the threshold wear level; and,
transmit the control signal to at least one pitch actuator of the wind turbine to control the at least one pitch bearing.
